(19) United States
(12) Patent Application Publication
(10) Pub. No.: US 2015/0184944 A1
(43) Pub. Date: Jul. 2, 2015

(54) INDICATOR FOR MONITORING FIRING IN THERMAL CERAMIC AND GLASS PROCESSES

(71) Applicant: Juan Jose Flores Simon, Paterna (ES)

(72) Inventor: Juan Jose Flores Simon, Paterna (ES)

(73) Assignee: AZULEJO DECORADO Y EXPORTACIÓN, S.L., Paterna, Valencia (ES)

(21) Appl. No.: 14/403,085

(22) PCT Filed: May 23, 2012
(86) PCT No.: PCT/ES2012/070371

§ 371 Date: Mar. 18, 2015

(51) Int. Cl. F27D 21/00; G01K 11/12; F27D 21/04

(52) U.S. Cl. CPC F27D 21/0014; F27D 21/04; G01K 11/12

(57) ABSTRACT

The invention relates to an indicator, which comprises a previously enamelled ceramic part, on which reactive inks that react with the temperature are deposited, displaying a series of variations on the surface thereof. The indicators have two types of reactive inks, which act as follows: • by surface change: the indicators have a predetermined printed surface which is known prior to firing and the size of said surface varies after firing in accordance with the temperature 1 time to which the indicator was exposed; Or • by colour change: the indicators have a predetermined surface printed with an ink which develops a specific colour in accordance with the temperature to which the indicator was exposed. The reactive inks used are advantageously lead-compound inks coloured with a cobalt ceramic pigment, or compounds of copper, nickel or iron, among others.

### OBJECT OF THE INVENTION

The present invention belongs to the field of controlling heat treatments above 800° C. for all types of ceramic and glass firing kilns, and particularly for roller firing kilns.

In the ceramic and glass industries the products are subjected to a firing process at different temperatures, starting at ambient temperature and increasing to a maximum temperature, after which they are cooled to ambient temperature again, all of the above within a specified time interval. To know which temperatures have been reached, the kilns have temperature regulators-controllers that receive electric signals from pyrometers. There are two types of kiln for firing ceramics. In one type, the bodies to be fired are static and are placed inside the kiln on a fixed platform, while in the other type the bodies move on a plane of rollers that passes through different sections of the kiln with different temperatures.

The temperature of the kilns is increased using gas burners or electric resistance heaters, microwaves, lasers, etc. The usual method for controlling temperature is the use of pyrometers, which send an electrical signal to the regulators, which in turn supply more or less energy until the specified temperatures are reached. This reading system has some drawbacks, as the recorded temperature depends on the pyrometers, the regulators, the chamber design, the thermal mass of the kiln materials, the body to be fired and the mass to be fired in a specified time, and in no case record the true temperature supported by the body but instead that of the surrounding atmosphere.

The indicator for monitoring firing of the invention is a flat object suitable for use in shuttle and even in roller kilns, where there is a limited useful height and wherein movement does not hinder the effectiveness of the body, the reactive surface of which object includes inks, has a negligible mass and is therefore not subject to the thermal inertia that can affect the results, thereby allowing data on the firing to be gathered.

The indicator evaluates the firing using two different and independent methods to increase accuracy:

1. The change in size of printed records on the indicator, that is, a quantifiable change in surface area;

2. The change in colour of a certain area of the indicator, which can be evaluated using appropriate tools such as a spectrophotometer, scanner, photographic camera, etc.

Thus, by obtaining a surface area value and colorimeter value for the firing temperature control indicator it is possible to determine, by comparison with a table of standard calibrated values, the firing dynamics to which the body has been subjected, providing an accurate image and a reference for subsequent firings as the indicator is a tool that records the specific firing conditions at a specific time.

### BACKGROUND OF THE INVENTION

In the current state of the art, pyrometric cones are known consisting of ceramic triangular bodies used as indicators in the firing process. When these are placed in the kiln in a vertical position they suffer a deformation that depends on the temperature and time that they experience.

This type of indicator is generally only applicable to static shuttle kilns in which the bodies remain static during firing. The drawback of this type of indicator is that it does not work correctly if the indicator is moved. In addition, the aging cycles required for correct operation are longer, as the indicators have a substantial volume-mass and require some time for the heat to penetrate the cone and generate a uniform pyroplastic deformation. There is a cone for each temperature range to be controlled, in increments of ten degrees Celsius.

Also known are control rings (Bullers, Philips or PCRT), which are cylinders having a specific diameter and in some cases a central hole, depending on the manufacturer. In this type of indicator the firing causes a contraction, such that the principle of operation is the measurement of the diameters before and after firing.

In this case the movement of the body in the kiln has no effect on the performance of the indicator, but the volume and mass thereof result in the same drawback as in pyrometric cones, since thermal inertias must be overcome that affect the readings, particularly in quick firing cycles shorter than 4 hours.

In ceramic kilns, particularly in roller kilns, firing cycles range from several hours to 29 minutes.

Specifically, in roller kilns the firing times are very short, such that the indicators of the present invention, due to their low mass and the reaction of the products on the surface thereof, minimise thermal inertia and provide a more reliable indication of the firing to which the body is subjected. The indicators of the present invention have two methods for obtaining values that are independent and ensure greater reliability of the data.

### DESCRIPTION OF THE INVENTION

The indicator for monitoring firing for thermal ceramic and glass processes overcomes the aforementioned drawbacks and provides additional advantages that will become apparent in view of the description provided below.

The indicator consists in a previously enamelled ceramic part, on which reactive inks that react with temperature are deposited, displaying a number of changes on the surface thereof. The indicators of the present invention have two types of reactive ink which act as follows:

a) Change in surface area. The indicators of the present invention have a predetermined printed surface area which is known prior to firing. After firing, the size of this surface area varies after firing in accordance with the temperature/time to which the indicator was exposed. This change can be measured.

b) Change in colour. The indicators of the present invention have a predetermined surface area printed with an ink which develops a specific colour in accordance with the temperature to which the indicator was exposed.

This colour can be measured using tools such as a spectrophotometer, scanner, digital camera and appropriate software.

The surface area of the body can be printed with the reactive inks using a decal (if the reactive ink is first transferred to a paper sheet and subsequently to the ceramic body) or by other means, such as digital ceramic inkjet printers. The advantage of using decals is the ease of transport and the lower deterioration of the printed surfaces during the handling of the indicators of the invention prior to firing.

The printing is transferred to a previously enamelled substrate with known features.

The pattern on the indicator will include various geometric shapes and figures. For inks that reach changing their surface area, concentric circles are used. Inspecting said circles allows determining the deformation suffered while applying the decal and determining that the application was correct.

An zone is also provided with a known surface area that will change after firing.

In addition, there is a zone with parallel lines of different thickness to provide a first indication of the deformation that takes place during the firing. These lines are made with ink of appropriate colour to clearly delimit the surface and have chromatic values that do not change with temperature.

Another zone is provided with a rectangular shape and semi-circular sides, sufficiently large to allow measuring the change in colour at the centre thereof with appropriate tools. The shape depicted with this ink is not relevant, but it must be such that it allows reading with measurement tools.

In addition to reactive inks, another non-reactive ink is required, preferably black, used for the text.

Thus, the indicator for monitoring firing for thermal ceramic and glass processes of the present invention reproduces the firing to which the parts are subjected, allowing the evaluation and quantification of the actual firing parameters of the kiln by comparison with predetermined data. Another application is the direct comparison of indicators to determine whether successive firings are similar.

To complete the description provided below and in order to aid a better understanding of the features of the invention, the present specification is accompanied by a drawings where, for purposes of illustration only and in a non-limiting manner, the most relevant details of the invention are shown.

### BRIEF DESCRIPTION OF THE DRAWINGS

FIG. 1. Shows the indicator for monitoring firing for thermal ceramic and glass processes according to the present invention.

### DESCRIPTION OF A PREFERRED EMBODIMENT

In the aforementioned figure a preferred and non-limiting embodiment is shown of the invention, consisting of a decal having:

On the top a rectangle is depicted with semi-circular minor sides, made with reactive ink that changes colour with temperature. This shape is appropriate for subsequent reading with the corresponding tools, such as a spectrophotometer.

Next are preferably four reactive strips arranged horizontally from greater to lower fusibility, each strip composed of two concentric circumferences and an inner circle, followed by five parallel lines of different thickness, after which are three squares. The first square is fully isolated and has 100% ink passage, and the following two have 66% and 33% ink passage respectively, using segments, and are joined by one side. This is followed by the word ‘control’. The squares will have a shape and size determining the specific surface area that will be quantified after firing.

The circles are used to indicate the correct application of the decal on the substrate, and must have a precise shape without deformations that lead to an elliptical or oval appearance.

A mere visual inspection of the five parallel lines with different thickness provides a first visual approximation of the deformation suffered by the ink.

The printed text after the squares (‘control’) allows appreciating the deformation suffered according to the clarity thereof, as it is easier to appreciate deformation of a text than that of a geometrical shape.

Lastly, there is a key printed in black non-reactive ink with the words temperature, cycle, date, time, site, right, left, and kiln. This ink is black, unalterable and does not react in colour or surface area.

The reactive inks and dyes used to print the circles and other control shapes are standard reactive inks and dyes, of the type used in ceramic frits that react with temperature changing their shape and colour.

According to their reactivity, three ink types are used classified into those that change in surface area depending on the temperature gradient, those that undergo chromatic changes and unreactive inks used in the key of the control indicator.

The reactive inks react on their surface and include in their composition ceramic frits with elements such as lead, boron, cobalt, zinc, zirconium, calcium, magnesium, sodium etc.

The changes in colours with temperature are represented in a indicator, preferably with a rectangular shape and semi-circular minor sides. The composition thereof includes metal oxides that cause the ‘instability’ in the colour provided by compounds of copper, nickel, vanadium, praseodymium, lead, tin, iron etc.

The non-reactive inks used are stabilised black ceramic inks including in their composition manganese, cobalt, iron, calcium, magnesium, etc.

In addition, the type of ink used allows obtaining control indicators for three temperature ranges:

1. Low temperature:

800° C.+1050° C.

2. Double firing and monoporosa:

950° C.+1200° C.

3. Gres and porcelain stoneware:

1100° C.+1250° C.

To obtain the decal, printing screens are used ranging from 24 to 150 threads per square centimetre, printed on adhesive paper.

The printing method consists in preparing the ink paste by mixing the ceramic components with a printing vehicle. The vehicle used is an oil for indirect printing (decals) composed of aromatic acrylic resins and glycol ester with an approximate solid to vehicle weight ratio of 10:4.

The six inks used in the indicator are applied successively, allowing each one to dry between applications, in the following order:

1) Black ink used for the text, centring the following inks with respect to this one in the order indicated below. Its composition includes ceramic inorganic compounds.

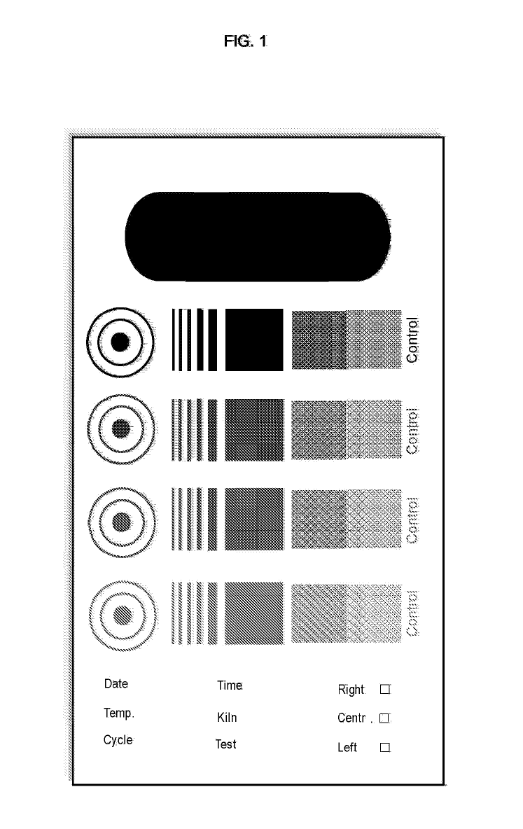

2) Reactive colour ink shown in FIG. 1 on the top, with a rectangular shape and rounded side edges. Its composition includes ceramic inorganic compounds.

3) First surface ink. Composed of a horizontal strip showing from left to right concentric circles, a square followed by two squares, and text indicating the Word ‘control’.

The number of threads per square centimetre of the printing screen used is 77. This is the most reactive ink and undergoes the greatest deformation during firing. In figure it is the first of the four horizontal strips. Its composition includes ceramic inorganic compounds.

4) Second surface ink. Similar in shape to the former but with a lower reactivity. In FIG. 1, in a vertically downwards sense it is the one following the ink described in step 3).

5) Third surface ink. Has the same shape as those of 3) and 4) but a lower reactivity tan the strip described in 4). In FIG. 1, it is the third strip from top to bottom of the four horizontal strips. Its composition includes ceramic inorganic compounds.

6) Fourth surface ink. Has the same shape as the former ink but is not reactive in surface area or colour. In FIG. 1, it is the fourth strip from top to bottom of the four horizontal strips. Its composition includes ceramic inorganic compounds.

7) Application on the entire surface of a binder known as collodion that joins the aforementioned inks into a single assembly; it is a transparent varnish composed of organic resins that are not affected in the firing of the indicator.

The decal obtained according to the method described above is applied on an enamelled substrate body with appropriate dimensions, made of White porous paste with a low iron content and good heat shock performance, low thermal inertia, and good dimensional stability in all the temperature ranges considered in this patent.

The enamelling of the substrate body preferably consists in a zirconium white with a white, shiny and opaque final appearance obtained by two applications: firstly an engobe that acts as an interface between the substrate and the enamel, minimising the imperfections and impurities and increasing the stability and uniformity of the colour of the substrate with respect to the colour of the enamel used, without interfering with the surface; and secondly the zirconium white opaque enamel itself, both of which are fired with the same firing curves.

The results obtained can be analysed using a scanner and/or a digital camera and/or a spectrophotometer to measure changes in the colour patch of the control indicator obtained and by the use of appropriate software for measuring increases in surface area.

The details and remaining accessories may be conveniently replaced by other technically equivalent ones without departure from the essence of the invention and the scope defined by the appended claims.

1. Indicator for monitoring firing for thermal ceramic and glass processes above 800° C., particularly in roller kilns, comprising a printed sheet in the form of a decal, characterised in that geometric control shapes are printed on the sheet such as circles, lines, squares, rectangles and text, made with reactive inks that react to the changes in temperature that take place during the firing process, changing the shape and colour of said shapes.

2. Indicator for monitoring firing according to claim 1, characterised in that the reactive ink that changes in shape and size of the printed surface preferably comprises a base of lead compounds coloured with a cobalt ceramic pigment.

3. Ceramic firing temperature control indicator in roller kilns according to claim 1, characterised in that the reactive ink the colour of which changes preferably comprises a base of compounds of copper, nickel, iron, vanadium-praseodymium among others.

4. Indicator for monitoring firing according to claim 1, characterised in that the printing screen used to obtain the decal ranges from 24 to 150 threads per cm2.

5. Indicator for monitoring firing according to claim 1, characterised in that the decal or ink printing is applied on an enamelled substrate body with appropriate dimensions, preferably made with a white porous paste including aluminium silicates.

6. Indicator for monitoring firing according to claim 5, characterised in that the enamelling of the substrate body preferably consists in a final zirconium white finish obtained by two applications, an engobe and above the same a zirconium enamel, both enamels being fired simultaneously with the same firing curves.
